(19) United States
(12) Patent Application Publication
(10) Pub. No.: US 2002/0078437 A1
(43) Pub. Date: Jun. 20, 2002

(54) Code load distribution

(75) Inventors: Kurt Albert Grassman, Jettingen (DE); Kurt Heinrich Naegele, Weilheim (DE); Frank Scholz, Kapellenbergstr (DE); Helmut H. Weber, Poughkeepsie (DE)

Correspondence Address: Floyd A. Gonzalez, IBM Corporation, 2455 South Road, P386, Poughkeepsie, NY, 12401, US

(73) Assignee: International Business Machines Corporation, Armonk, NY

(21) Appl. No.: 10/016,945

(22) Filed: Dec. 14, 2001

(30) Foreign Application Priority Data
Dec. 15, 2000 (EP) 00127576.7

(51) Int. Cl. G06F 9/44

(52) U.S. Cl. 717/168

(57) ABSTRACT

The present invention relates to networked computer systems, and in particular to a method and system for improved update facilities for software programs installed on a subset of said networked computers. It is based on the concept that updating the supplier nodes and updating the dependent nodes have to be hierarchically separated from each other. The following sequence of steps is performed: selecting a first subgroup (20) comprising at least one dependent computer (24), selecting a second subgroup comprising at least one of the supplier computers (14) for providing the updated version means exclusively to dependent computers (24,26) until a predetermined condition has occurred, loading at least one computer (24) of the first subgroup (20) with an updated version means during continued operation of the unselected plurality of dependent computers (26,28,30) with a former version means.

### BACKGROUND OF THE INVENTION

The present invention generally relates to networked computer systems, and in particular to a method and system for improved update facilities for software programs installed on a subset of said networked computers.

The present invention is generally applicable in computer networks comprising a plurality of node computers, and where said network has some inner structure of ‘competence distribution’, in particular a structure in which a first type of server computers and a second type of serviced computers, in particular embedded controllers or other type of computer function contained in networked stations, exist.

Although the present invention has a quite general scope which does not necessarily specify both types beyond the fact that there is some functional difference between said both types of computers—the present invention will be illustrated and compared to a specific prior art update method applied in situations in which said serviced computers are embedded controllers managing a specific input/output (I/O) device out of a large variety of devices, like for example terminals, different storage devices, printers, data input devices, etc., like it is the case for example in a high performance clustered network in which a large plurality of server nodes cooperate with one or more respective embedded controllers.

Said embedded controllers or other computer functions are computing devices which have a hard disk memory, or any other non-volatile memory or persistent storage media. They have a processor unit comprising some associated RAM as a main memory in order to execute the specific code required for fulfilling a specific task. Thus, they need for example an executable code image for doing their work. This executable image may or may not be locally stored depending on availability of a persistent memory device. Said code must now be updated from time to time out of a variety of reasons not being a subject of discussion in here. In a situation where many new code loads, e.g., microcode or any other software update must be shipped through the network in order to update a large variety of controllers the question arises how to do this job best.

A prior art update method for the above mentioned type of embedded network systems uses a plurality of supplier nodes for distributing a new code load for said update purposes. With this measure the distribution process can be achieved quite fast, in particular when there is a large plurality of (controlled) nodes to be supplied. In order to maintain version consistency across the whole network the prior art approach interrupts the business operation of the supplied nodes for the duration of the update process. Furthermore it runs the risk of providing a code load that may not be capable of correctly operating some of the updated nodes. This interruption, however, represents a general, business-relevant disadvantage in any type of network which is in professional use.

It is, however, even a grave disadvantage which can hardly be tolerated at least when network applications require a permanent or quasi-permanent operational availability.

An ‘ideal’ method of code load distribution, and in particular best adapted for the above mentioned type of network systems satisfies the following Code Load Distribution Requirements:

1. High-availability of service: Code loads for a larger set of network nodes should not be stored on a single server which could become a single point of failure (SPOF). Thus multiple service nodes should store the code load for avoiding SPOFs and for performance reasons in order to be able to serve multiple requesters by multiple servers.

2. Maintenance of consistency: At least a level of compatibility between the code loads supplied to different nodes has to be maintained if these nodes have to communicate among themselves. And their capability to communicate with service nodes must not be destroyed.

3. Concurrent maintenance: The process of updating the code load should not prevent the updated network from providing or sustaining its operations.

4. Automatic recovery from errors: A distribution mechanism for code loads may fail due to error conditions but it must not leave the network in an inconsistent state. For instance, the expected consistency criteria (“all computers store and run the same version of code load”, see (2) above) must be retained as the result of an automatic recovery of the distribution mechanism.

Thus, a controlled distribution of code loads and updates to the networked nodes is required under the constraints imposed by the requirements stated above.

### SUMMARY OF THE INVENTION

It is thus an object of the present invention to improve the update procedure in view of the above mentioned requirements.

According to its broadest aspect the present invention discloses a method for updating programs to be used in a network comprising a plurality of first type computers having a limited, i.e., a somehow dedicated function range relative to a plurality of second type computers having a respective extended service function range, a service being defined as comprising update services to be performed by the second type computers to said first type computers, the method comprising the steps of: selecting a first subgroup comprising at least one first type computer, selecting a second subgroup comprising at least one of the second type of computers for providing the updated version means exclusively to first type computers until a predetermined condition has occurred, loading at least one computer of the first subgroup with an updated version means during continued operation of the unselected plurality of first type computers with a former version means. The above method can be run e.g., by an adapted supplier node software, possibly triggered by a system operator.

By said loading step the update process is at least initiated, in some network situations it is already completed. According to this inventive feature the code load thus can be performed without interrupting the operation of the unselected first and second type nodes which is very strongly desired whenever the operation of the network should be permanently available. The valid version relevant for the business operation is still the former version at this point in time. But the new version can be validated and a signal can be issued to declare the new version as basically adapted to be operable, which will be done in some situations not before a test of the new version has been performed successfully.

Advantageously, a step of testing at least one computer of the first subgroup with said updated version means can be performed during continued operation of the unselected plurality of said first type computers, followed by the step of distributing said updated version means over the remaining plurality of unselected computers if a test result corresponds to predetermined result scheme, i.e., the test could be evaluated as successful.

Then, in a further advantageous extension a step of distributing the updated version means among the second type of computers is performed, while preventing said second type of computers for providing services—in particular a desired or requested code load with the former version—as long as they are not provided with the updated version means.

By that it is assured that only the new version is distributed across the second type computers for further download to the first type computers. In case of a desired recovery to the former version it is assured that no more than two versions exist in the plurality of supplier nodes. This helps to increase consistency and avoids version conflicts and ambiguities related therewith. The present invention is thus advantageously applicable when an increased availability—nearly permanent—of the operability of network components is required. This is in particular the case in redundantly configured network systems.

Further, the inventive concepts can be applied both to network systems that are constructed as “internal” networks, for instance, within a domain of centrally controlled computers, and also to “open” networks with dynamically changing participants according to a “subscriber” model.

The code load may comprise entire operating system packages or updates therefore only, application program sources, or executable program packages, or updated executable code images, or any combinations thereof, dependent of the function range of the serviced computers.

The proposed solution satisfies the following assertions:

I1. All supplier nodes store the same identical code load version after initial installation.

I2. All supplier nodes store the same identical code load version after successful termination of the update process.

I3. When the update process does not successfully terminate then the set of supplier nodes is logically partitioned into a set with the previous version of the code load and a set with the latest version of the code load. There will never be a third version stored on any supplier node. Item (I2) will be recovered by the proposed procedure.

The two levels of the code load distribution problem are treated by separating the functions being executed on supplier and dependent nodes thus applying best practices of software engineering. The solution features the following steps or phases:

I. Initial installation of supplier nodes.

II. Operational mode of supplier nodes.

III. Startup phase of dependent nodes.

IV. Installation of updates on supplier nodes.

V. Validation of new code loads on dependent nodes.

VI. Recovery from a broken update process on supplier nodes.

VII. Reconciliation between S- and D-groups upon recovery.

As an additional advantage of the inventive concept the code load is balanced which avoids peaks in network traffic.

### BRIEF DESCRIPTION OF THE DRAWINGS

These and other objects will be apparent to one skilled in the art from the following detailed description of the invention taken in conjunction with the accompanying drawings in which:

FIG. 1 is a schematic block diagram showing the most essential elements, i.e., supplier and dependent peer node groups in a non-redundant network system used for the present invention according to one preferred aspect thereof,

FIG. 2 is a schematic block diagram showing the basic control flow of the code load distribution of an inventive embodiment, in an overview form,

FIG. 3 is a schematic block diagram showing the basic control flow of the code load distribution of said inventive embodiment, as contributed by the s-node controllers in a more detailed form, and

FIG. 4 is a schematic block diagram showing the basic control flow of the code validation of said inventive embodiment, as contributed by the d-node devices in a more detailed form.

### DESCRIPTION OF THE PREFERRED EMBODIMENT

Some preliminary notions are defined that are required to describe the inventive concepts in view of the preferred embodiment described later below.

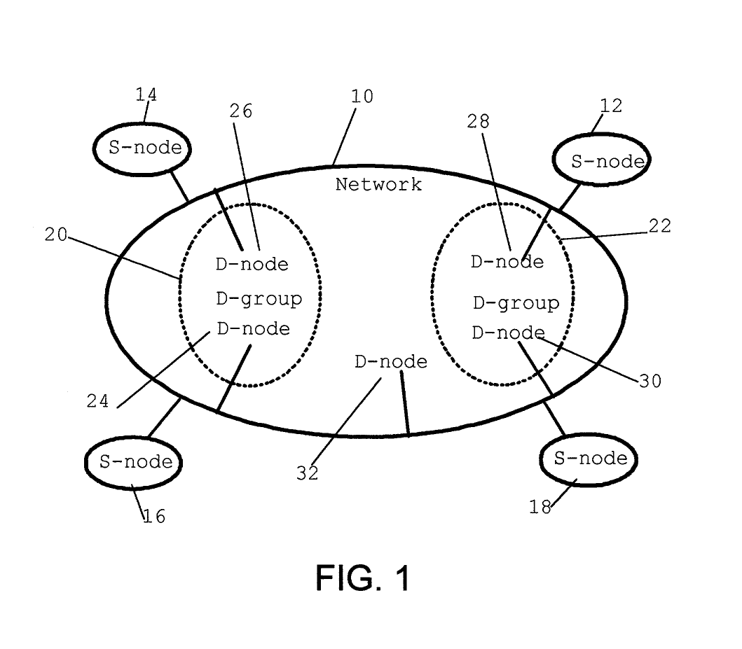

Said basic definitions represent a key for systematically analyzing and understanding the problems of code replacement or software update under the heavily strong requirements as they are set out above. With this systematic definition catalogue a person skilled in the art will get an easy access to the inventive concepts. References are made to FIG. 1 where appropriate:

Definition 1: Supplier node:

A supplier node denoted with reference signs 12, 14, 16, 18 is a networked computer that persistently stores code loads and updates therefore in its local file system in predefined locations. A supplier node also represents a “point of service” for the entire network 10. These supplier nodes can be for example:

service control computers that are the service access points for large computer configurations, or

application server computers that provide application and operating system packages or updates to dependent or subscribed computer nodes.

Definition 1.1: Acting and Non-Acting Supplier Node.

An acting supplier node is in enabled state thus being able to act on incoming requests for the stored code loads. A non-acting supplier node has been put into disabled state to prevent its locally stored code loads from being distributed.

Definition 2: Dependent Node.

A dependent node 24, 26, 28, 30, 32 requests code load services from supplier nodes. The most basic service is the request for a code load to start its execution from. The basic request may be issued by a low- or high-level (see Definition 7 later below) program. These nodes can be

embedded controllers,

regular workstations that depend on server computers to provide application and operating system packages or updates.

Definition 3: Peer Node and Peer Node Groups:

A peer node group is defined as a subset of equal nodes in a network in the sense that all members of the subset can provide the same set of services to a given set of service consumers at a given point in time. Peer groups may be arbitrarily defined, for example according to some functional requirements, for instance, a group of nodes having access to a common hardware resource. A peer node is one of the nodes belonging to a peer node group.

The notion of a peer associates two meanings: First, any node in the peer group may provide the requested service. Second, it is transparent to the service consumers which node from the peer group is actually providing the service.

It should be noted that peer nodes provide an architectural means to hide the actual implementation of the internal mechanisms within the peer group. The way the requested services are provided is transparent to the requesters. An actual implementation may even be based on the master-slave principle with only a master node being able to provide a service. Or, a more peer-oriented design that is based on data replication may be used.

Two types of node groups are defined:

1) Supplier peer groups (S-groups) consisting of supplier nodes.

2) Dependent peer groups 20, 22 (D-groups) consisting of dependent nodes with or without redundant nodes from a functional point of view.

For simplicity it is assumed that only one supplier peer group exists. There can be multiple dependent peer groups.

Definition 4: Peer Network:

A peer network consists of networked peer nodes. Such a network may be composed of redundant components to increase availability. But this is not a requirement for the sake of the present invention's disclosure and scope.

The use of particular network technologies is not required. But some of the proposed solutions can only be implemented on shared media networks such as Ethernet standards.

No requirements on networking topology are imposed by the inventive concepts. But it is considered advantageous if the supplier nodes can communicate among each other without having to involve dependent nodes.

Definition 5: Code Load and Identification of Version:

A code load is defined as the set of programs that are required to request and execute services on the respective node. On some systems a code load may consist of the operating system only. On other systems additional application codes will be packaged into the code load.

It is assumed that a code load for a dependent node consists of one code package only, for instance, the packaged operating system with all applications.

The code loads for dependent nodes are stored on the supplier nodes as a set of files that can be updated by means of an install procedure.

All code loads, the stored file version and the running version contain a version identifier that can be retrieved at runtime both by supplier nodes and by dependent nodes.

Definition 6: Provider Service:

On the supplier nodes a functional service is resident that intercepts requests for code loads from dependent nodes. This service is typically called a boot service in prior art if it provides code loads for operating systems. But if it provides application packages then it may just be called an application load service.

In order to satisfy the above mentioned requirements this service has to be augmented by configuration services that maintains data on S- and D-group nodes which are not part of the presented invention, for instance, the capability to know (identification) and validate (authorization) if a node belongs to any group.

Definition 7: Requester Service:

The new code load has to be requested by dependent nodes. Then the dependent node is put into “request” mode. The request may be issued by low-level code, for instance, BIOS-level software, or high-level code residing within an operating system or application program.

All versions of requester services can access the local system configuration for identifying the local node.

The distribution of code loads occurs on two levels in a peer network of supplier and dependent nodes:

A. Between supplier nodes in the supplier node group to update to stored loads.

B. From supplier nodes to dependent nodes.

The problem to be solved and mentioned under 1.3 above encompasses the controlled distribution of code loads under the above mentioned requirements within the supplier node group and to the dependent node groups.

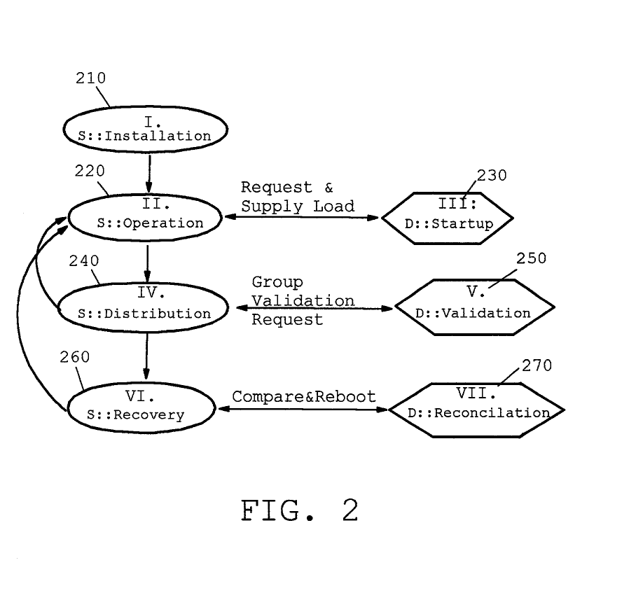

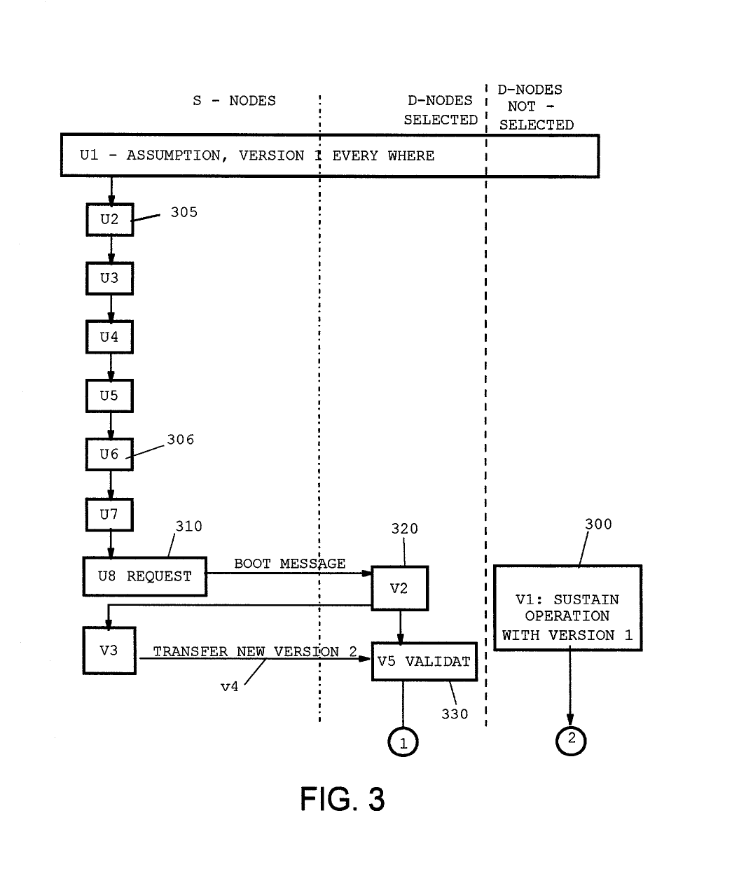

In the exemplary shown environment depicted in FIG. 1 the following basic technical requirements and operations are required to be present. These requirements relate to the specifics of the particular embodiment of the inventive code distribution method as it is described in more detail later below and with reference to FIGS. 2 and 3.

On the supplier nodes:

1) Disable/enable operation for state transitions of supplier nodes from acting to non-acting mode, and vice versa, respectively.

2) Retrieval of code load version from a stored code load file.

3) Retrieval of code load version from a running instance on a dependent node.

4) Comparison operation of code load versions.

The dependent nodes are required to do the following:

1) Execution of a requester service code on dependent nodes.

2) Broadcast capability of the network interface to shared media network to be receivable by all enabled supplier nodes.

With general reference to the figures and with special reference now to FIG. 2 an overview on the inventive update method embodiment is given.

In FIG. 2 actions to be performed by the supplier nodes, abbreviated as S are to be seen on the left side, those for the dependent nodes, abbreviated with D are on the right side.

First, an initial installation takes place at the supplier nodes, step 210. Therefore, the following sequence of steps i1) to i4) will be performed:

i1) The same initial code loads for dependent nodes is installed on all supplier nodes.

i2) All supplier nodes are enabled as acting nodes.

i3) The boot and configuration service is activated upon startup of the supplier node platform.

i4) The dependent nodes can be serviced now.

Thus the system is ready for the operational phase—block 220—of an active supplier node. The following sequence of steps will be performed:

o1) The active supplier node waits for request messages from dependent nodes.

o2) If a message arrives the active supplier node prepares and sends a reply message containing its own identity and opens a service session with this dependent node to transmit the code load.

o3) It honors transmit protocol messages from the dependent node until the requested service is finished, i.e., the load is supplied to the requesting dependent node.

o4) Then, it waits again for further messages.

Then, the startup and request phase of a dependent node is performed, block 230:

d1) When a dependent node is turned on it immediately starts executing its low-level requester service code. When the dependent node is already in operational mode then a high-level requester code takes over this role.

d2) The requester code accesses local information to identify itself. This step can be omitted if there is no need for a unique identification for addressing purposes.

d3) The requester code prepares a so-called boot message to be broadcast to the network. This boot message may advantageously follow the BOOTP standard as for example described in the Internet RFCs 1497, and 1542. The hardware data including its own identification is stored into this boot message.

d4) The requester code waits for responses from any supplier node.

d5) It continuously repeats sending these boot messages until a response is received.

d6) The first response from any supplier node is accepted.

d7) A conversational protocol is executed with the responding supplier node.

This was a description of the regular, usually intended operation between supplier and dependent node.

With special additional reference now to FIG. 3 the distribution of updates to supplier peer group and depended node groups according to the inventive embodiment is described next. This corresponds to the sequence of blocks 240, 250, 260, and 270.

In FIG. 3 steps of the supplier nodes are depicted left, whereas steps of the dependent nodes are depicted right, with a particularity that steps to be performed by the selected dependent nodes are more left and those of the unselected dependent nodes are at the right margin.

u1) First it is assumed that all nodes in a supplier peer group S have installed the same version V1 of their code loads for multiple dependent peer groups. Initially the first available version of the code load will be installed on all supplier nodes before the nodes are put into production.

u2) A single node s′ of the supplier peer group S, i.e., one of the nodes 12, 14,16, or 18 is selected as the new version supplier node by manual intervention.

u3) s′ puts himself into non-acting mode.

u4) s′ informs all other nodes s, i.e., the remaining supplier nodes S about its new role.

u5) The code loads on s′ will be updated to a new version V2.

u6) s′ requests that all other nodes s of the peer group S put themselves into non-acting mode and monitor the progress of s′.

u7) s′ puts itself back into acting-mode.

u8) s′ requests, step 310, that some nodes of the dependent peer groups will update their code load by loading it from s′ and by thus validate the new version V2, see the section about validation below.

The validation of the new code load on dependent nodes takes place as follows:

v1) The new version supplier node issues reboot requests to subsets of dependent nodes, step 320. For instance, at least one node from each dependent group may be selected. This set of selected nodes must form a proper subset of the entire set of dependent nodes. The non-selected nodes continue to sustain the operations of the hardware attached to the dependent node group, step 300—with version V1, the former version of the code.

v2) The selected dependent nodes return to requester mode, and start sending boot messages, step 320.

v3) These boot messages will be honored by the new version supplier node only.

v4) The regular transmission of the new code load takes place, see the arrow v4.

v5) The successful startup of the selected dependent nodes is checked by a configuration service on the supplier node, step 330.

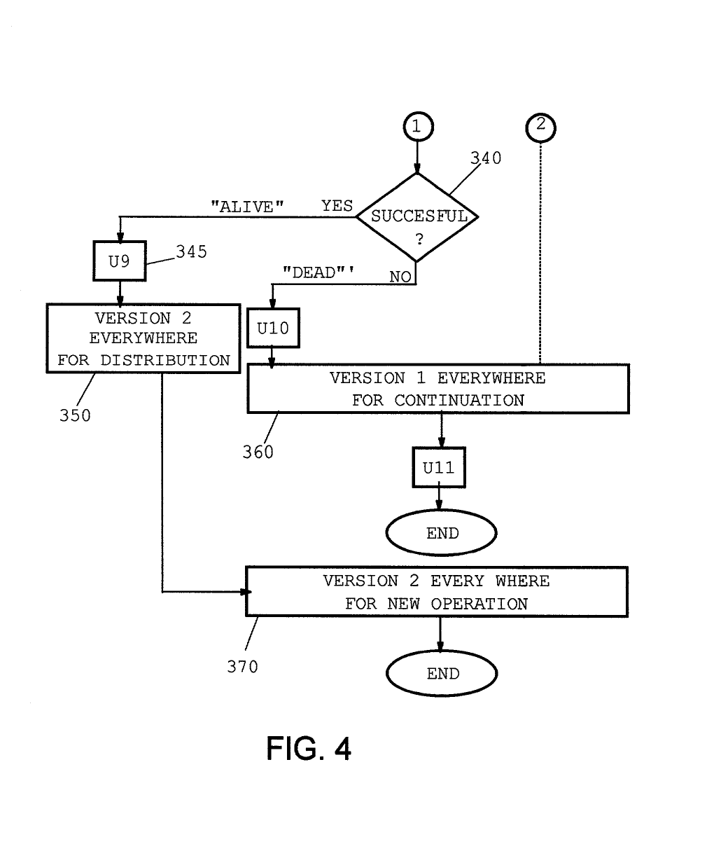

If the test 340—see now FIG. 4 in continuation of FIG. 3—is successful then a “keep-alive” message can be sent out by each dependent node that will be intercepted by a configuration service at the selected supplier node.

u9) If the validation was successful then s′ requests that each s of the remaining supplier nodes updates its code load storage, e.g., via mirroring it from s′ and puts itself back to acting mode. Upon completion of this s′ resets its role as a new version supplier, step 350.

Step 370) All other dependent nodes are ordered to refresh their loads accordingly. In the end, then new version V2 is everywhere on all dependent nodes as well as on all supplier nodes. Thus, version consistency is achieved clearly.

u10) If the validation was unsuccessful for at least one dependent node, see the NO-branch of decision 340, then s′ puts itself into non-acting mode, resets its role as a new version supplier, broadcasts this to all its remaining peers s out of the peer group S, picks a single s″ from S, updates its code load storage to the previous version v1 via mirroring it from s″ and finally puts itself back to acting mode again. A simpler way would be to re-install the former version V1 load from a local file system on node s′ if a backup copy had been stored.

U11) All selected dependent nodes have to be reset to version v1 by requesting them to drop version v2 and reload version v1 again.

Thus, the former version V1 is everywhere for operation.

It should be noted that the actual implementation of this concept depends on the internal design of the peer group. For instance, if it runs as a master-slave group then the selected subset will only be drawn from the slave nodes. The mastership has to be switched in order to test the new load under master conditions.

Finally, a process control for achieving recovery from a broken update process on supplier nodes is given next.

The assumption here is that the process described under u9) has not completed because the selected new version supplier node has crashed before all other supplier nodes have been updated successfully. The process continues as long as a single new version supplier node is active:

X1) Another new version supplier node has to be selected in this situation. This will happen because the monitoring protocol between the above said ‘remaining’ supplier nodes and the selected on s′ will be interrupted. The remaining supplier nodes determine the next master by executing a tie-breaker protocol based on their local id (number) and the version identifier of the code load they locally store. The one with the greatest number and the latest version wins. Such algorithms are known to a person skilled in the art.

Thus, it can be assumed that a s″ node out of the remaining group has been elected. Then the following sequence of steps will be undertaken;

x2) Supplier node s″ reads out the version identifier of the code load stored in its file system.

x3) Supplier node s″ sends its version identifier to all dependent nodes in the form of a “compare&reboot” request, see back to FIG. 2, block 260.

x4) When this recovery terminates all dependent nodes with a “wrong” code load have been reset to the code load stored at this temporary master supplier node.

Finally, a reconciliation process is described between S- and D-groups upon recovery, block 270, FIG. 2:

y1) A dependent node receives a “compare&reboot” request containing a version number for reconciliation.

y2) The local version number is retrieved and compared. If it is different than the received version identifier it will immediately reset its operation and go into reboot mode, see above under d1), block 230, “Startup and execution phase of dependent node”.

Thus, even a breakdown situation in the critical code distribution phase between supplier nodes can be successfully healed.

As it reveals from the above description the present invention represents a large step forward to version consistency and overall system availability.

In the foregoing specification the invention has been described with reference to a specific exemplary embodiment thereof. It will, however, be evident that various modifications and changes may be made thereto without departing from the broader spirit and scope of the invention as set forth in the appended claims. The specification and drawings are accordingly to be regarded as illustrative rather than in a restrictive sense.

The present invention is thus based on the concept that the two problem levels of updating the supplier nodes and the dependent nodes have to be hierarchically separated from each other: The inventive method for distribution of code loads between supplier nodes works among those nodes only. A service from dependent nodes must not be required to achieve the updating of supplier nodes.

This basic inventive concept is applicable whenever the initial configuration of the supplier nodes has to be changed because new code loads become available for distribution. Mirroring techniques can advantageously be used from a single supplier node to the other nodes in the supplier peer group. During the mirroring time the receiving supplier nodes are temporarily disabled as acting supplier nodes.

There is a broad field of application: enterprise networks, vast industry plants in which the first type computers are embedded controllers maybe controlling some actor device in a production line. As larger the number of s- or d-nodes is the more relevant the advantages of the inventive concept become.

The present invention can be realized in hardware, software, or a combination of hardware and software. A code load distribution/update control tool according to the present invention can be realized in a centralized fashion in one computer system, or in a distributed fashion where different elements are spread across several interconnected computer systems. Any kind of computer system or other apparatus adapted for carrying out the methods described herein is suited. A typical combination of hardware and software could be a general purpose computer system with a computer program that, when being loaded and executed, controls the computer system such that it carries out the client or server specific steps of the methods described herein.

The present invention can also be embedded in a computer program product, which comprises all the features enabling the implementation the respective steps of the methods described herein, and which—when loaded in one or more computer systems—is able to carry out these methods.

Computer program means or computer program in the present context mean any expression, in any language, code or notation, of a set of instructions intended to cause a system having an information processing capability to perform a particular function either directly or after either or both of the following:

a) conversion to another language, code or notation;

b) reproduction in a different material form.

While the preferred embodiment of the invention has been illustrated and described herein, it is to be understood that the invention is not limited to the precise construction herein disclosed, and the right is reserved to all changes and modifications coming within the scope of the invention as defined in the appended claims.

What is claimed is:

1. A method for updating programs to be used in a network comprising a plurality of first type computers having a limited function range relative to a plurality of second type computers having a respective extended function range, a service being defined as comprising update services providing an updated facilities version to be performed by the second type computers to said first type computers, the method comprising the steps of:
selecting a first subgroup comprising at least one first type computer;
selecting a second subgroup comprising at least one of the second type of computers for providing said updated facilities version exclusively to first type computers until a predetermined condition has occurred; and
loading at least one computer of the first subgroup with said updated facilities version during continued operation of the unselected plurality of first type computers with a former version means.

2. The method according to claim 1, further comprising the steps of:
testing at least one computer of the first subgroup with said updated facilities version during continued operation of the unselected plurality of first type computers; and
distributing said updated facilities version over the remaining plurality of unselected computers if a test result corresponds to a predetermined result scheme.

3. The method according to claim 1, further comprising the steps of:
distributing the updated facilities version among the second type of computers; and
preventing them from providing services as long as they are not equipped with the updated facilities version.

4. The method according to claim 1 in which said first type of computers are embedded controllers and the service of the second type computers comprising the provision of code loads to the first type of computers.

5. The method according to claim 1 for updating programs in an enterprise network.

6. The method according to claim 1 for updating software of embedded controllers in an enterprise network.

7. The method according to the claim 1 for updating software of embedded controllers in a computer-controlled industry plant.

8. An apparatus for updating programs to be used in a network comprising a plurality of first type computers having a limited function range relative to a plurality of second type computers having a respective extended function range, a service being defined as comprising update services providing an updated facilities version to be performed by the second type computers to said first type computers, the apparatus comprising:
a first selector selecting a first subgroup comprising at least one first type computer;
a second selector selecting a second subgroup comprising at least one of the second type of computers for providing said updated facilities version exclusively to first type computers until a predetermined condition has occurred; and
a loader loading at least one computer of the first subgroup with said updated facilities version during continued operation of the unselected plurality of first type computers with a former version means.

9. The apparatus according to claim 8, further comprising:
a tester testing at least one computer of the first subgroup with said updated facilities version during continued operation of the unselected plurality of first type computers; and
a distributor distributing said updated facilities version over the remaining plurality of unselected computers if a test result corresponds to a predetermined result scheme.

10. The apparatus according to claim 8, further comprising:
a distributor distributing the updated facilities version among the second type of computers; and
preventing means for preventing them from providing services as long as they are not equipped with the updated facilities version.

11. The apparatus according to claim 8 in which said first type of computers are embedded controllers and the service of the second type computers comprising the provision of code loads to the first type of computers.

12. The apparatus according to claim 8 further comprising means for updating programs in an enterprise network.

13. The apparatus according to claim 8 further comprising means for updating software of embedded controllers in an enterprise network.

14. The apparatus according to the claim 8 further comprising means for updating software of embedded controllers in a computer-controlled industry plant.

15. A program product usable for updating programs to be used in a network comprising a plurality of first type computers having a limited function range relative to a plurality of second type computers having a respective extended function range, a service being defined as comprising update services providing an updated facilities version to be performed by the second type computers to said first type computers, said program product comprising:
a computer readable medium having recorded thereon computer readable program code means for performing the method comprising:
selecting a first subgroup comprising at least one first type computer;
selecting a second subgroup comprising at least one of the second type of computers for providing said updated facilities version exclusively to first type computers until a predetermined condition has occurred; and
loading at least one computer of the first subgroup with said updated facilities version during continued operation of the unselected plurality of first type computers with a former version means.

16. The program product according to claim 15, wherein said method further comprises:
testing at least one computer of the first subgroup with said updated facilities version during continued operation of the unselected plurality of first type computers; and
distributing said updated facilities version over the remaining plurality of unselected computers if a test result corresponds to a predetermined result scheme.

17. The program product according to claim 15 wherein said method further comprises:
distributing the updated facilities version among the second type of computers; and
preventing them from providing services as long as they are not equipped with the updated facilities version.

18. The program product according to claim 15 in which said first type of computers are embedded controllers and the service of the second type computers comprising the provision of code loads to the first type of computers.

19. The program product according to claim 15 for updating programs in an enterprise network.

20. The program product according to claim 15 for updating software of embedded controllers in an enterprise network.

21. The program product according to the claim 15 for updating software of embedded controllers in a computer-controlled industry plant.
